(19) United States
(12) Patent Application Publication
(10) Pub. No.: US 2014/0098111 A1
(43) Pub. Date: Apr. 10, 2014

(54) DATA PROCESSING SYSTEM FOR TRANSMITTING COMPRESSED DISPLAY DATA OVER DISPLAY INTERFACE

(71) Applicant: Mediatek Inc., Hsin-Chu (TW)

(72) Inventors: Chi-Cheng Ju, Hsinchu City (TW); Tsu-Ming Liu, Hsinchu City (TW)

(21) Appl. No.: 13/913,520

(22) Filed: Jun. 10, 2013

Related U.S. Application Data
(60) Provisional application No. 61/711,319, filed on Oct. 9, 2012.

(51) Int. Cl. G06T 9/00

(52) U.S. Cl. CPC G06T 9/00
USPC 345/502

(57) ABSTRACT

A data processing system has a first data processing apparatus and a second data processing apparatus. The first data processing apparatus includes a first controller, a display processor, a compressor and an output interface. The first controller controls the first data processing apparatus. The display processor generates a first input display data. The compressor generates a compressed display data according to the first input display data. The output interface packs the compressed display data into a bitstream, and outputs the bitstream via a display interface. The second data processing apparatus includes an input interface, a second controller, a display buffer and a de-compressor. The input interface un-packs the bitstream into a second input display data. The second controller controls the second data processing apparatus. The display buffer buffers the second input display data and outputs a buffered display data. The de-compressor de-compresses the buffered display data.

### CROSS REFERENCE TO RELATED APPLICATIONS

This application claims the benefit of U.S. provisional application No. 61/711,319, filed on Oct. 9, 2012 and incorporated herein by reference.

### BACKGROUND

The disclosed embodiments of the present invention relate to transmitting display data over a display interface, and more particularly, to a data processing system which transmits compressed display data over a display interface.

A display interface is disposed between a first chip and a second chip to transmit display data from the first chip to the second chip for further processing. For example, the first chip may be a host application processor, and the second chip may be a driver integrated circuit (IC). The display data may include image data, video data, graphic data, and/or OSD (on-screen display) data. Besides, the display data may be single view data for two-dimensional (2D) display or multiple view data for three-dimensional (3D) display. When a display panel supports a higher display resolution, 2D/3D display with higher resolution can be realized. Hence, the display data transmitted over the display interface would have a larger data size/data rate, which increases the power consumption of the display interface inevitably. If the host application processor and the driver IC are both located at a portable device (e.g., a smartphone) powered by a battery device, the battery life is shortened due to the increased power consumption of the display interface. Thus, there is a need for an innovative design which can effectively reduce the power consumption of the display interface.

### SUMMARY

In accordance with exemplary embodiments of the present invention, a data processing system which transmits compressed display data over a display interface is proposed to solve the above-mentioned problem.

According to a first aspect of the present invention, an exemplary data processing system is disclosed. The exemplary data processing system has a first data processing apparatus and a second data processing apparatus. The first data processing apparatus includes: a first controller, arranged for controlling operations of the first data processing apparatus; a display processor, arranged for generating a first input display data; a compressor, arranged for receiving the first input display data and generating a compressed display data according to the first input display data; and an output interface, arranged for packing the compressed display data into a bitstream, and outputting the bitstream via a display interface. The second data processing apparatus is for driving a display apparatus, and includes: an input interface, arranged for receiving the bitstream via the display interface, and un-packing the bitstream into a second input display data; a second controller, arranged for controlling operations of the second data processing apparatus; a display buffer, arranged for buffering the second input display data and outputting a buffered display data; and a de-compressor, arranged for de-compressing the buffered display data when receiving the buffered display data.

According to a second aspect of the present invention, an exemplary data processing system is disclosed. The exemplary data processing system has a first data processing apparatus and a second data processing apparatus. The first data processing apparatus includes: a first controller, arranged for controlling operations of the first data processing apparatus; a display processor, arranged for generating a first input display data; a compressor, arranged for receiving the first input display data and generating a compressed display data according to the first input display data; and an output interface, arranged for packing the compressed display data into a bitstream, and outputting the bitstream via a display interface. The second data processing apparatus is for driving a display apparatus, and includes: an input interface, arranged for receiving the bitstream via the display interface, and un-packing the bitstream into a second input display data; a second controller, arranged for controlling operations of the second data processing apparatus; and a de-compressor, arranged for de-compressing the second input display data.

According to a third aspect of the present invention, an exemplary data processing system is disclosed. The exemplary data processing system has a first data processing apparatus, a second data processing apparatus and a third data processing apparatus. The first data processing apparatus is arranged for generating a first input display data, packing the first input display data into a first bitstream, and outputting the first bitstream via a first display interface. The second data processing apparatus includes: a first input interface, arranged for receiving the first bitstream via the first display interface, and un-packing the first bitstream into a second input display data; a compressor, arranged for receiving the first input display data and generating a compressed display data according to the first input display data; and an output interface, arranged for packing the compressed display data into a second bitstream, and outputting the second bitstream via a second display interface. The third data processing apparatus is for driving a display apparatus, and includes: a second input interface, arranged for receiving the second bitstream via the second display interface, and un-packing the second bitstream into a third input display data; a second controller, arranged for controlling operations of the third data processing apparatus; a display buffer, arranged for buffering the third input display data and outputting a buffered display data; and a de-compressor, arranged for de-compressing the buffered display data when receiving the buffered display data.

According to a fourth aspect of the present invention, an exemplary data processing system is disclosed. The exemplary data processing system has a first data processing apparatus, a second data processing apparatus and a third data processing apparatus. The first data processing apparatus is arranged for generating a first input display data, packing the first input display data into a first bitstream, and outputting the first bitstream via a first display interface. The second data processing apparatus includes a first input interface, arranged for receiving the first bitstream via the first display interface, and un-packing the first bitstream into a second input display data; a compressor, arranged for receiving the first input display data and generating a compressed display data according to the first input display data; and a second output interface, arranged for packing the compressed display data into a second bitstream, and outputting the second bitstream via a second display interface. The third data processing apparatus is for driving a display apparatus, and includes: a second input interface, arranged for receiving the second bitstream via the second display interface, and un-packing the second bitstream into a third input display data; a second controller, arranged for controlling operations of the third data processing apparatus; and a de-compressor, arranged for de-compressing the third input display data.

According to a fifth aspect of the present invention, an exemplary data processing system is disclosed. The exemplary data processing system has a first data processing apparatus, a second data processing apparatus and a third data processing apparatus. The first data processing apparatus includes a controller, arranged for controlling operations of the first data processing apparatus; a display processor, arranged for generating a first input display data; a compressor, arranged for receiving the first input display data and generating a compressed display data according to the first input display data; and a first output interface, arranged for packing the compressed display data into a first bitstream, and outputting the first bitstream via a first display interface. The second data processing apparatus includes: an input interface, arranged for receiving the first bitstream via the first display interface, and un-packing the first bitstream into a second input display data; a de-compressor, arranged for generating a de-compressed display data according to the second input display data; and a second output interface, arranged for packing the de-compressed display data into a second bitstream, and outputting the second bitstream via a second display interface. The third data processing apparatus is arranged for receiving the second bitstream and driving a display apparatus according to the de-compressed display data derived from the second bitstream.

According to a sixth aspect of the present invention, an exemplary data processing system is disclosed. The exemplary data processing system has a first data processing apparatus and a second data processing apparatus. The first data processing apparatus includes: a first controller, arranged for controlling operations of the first data processing apparatus; a display processor, arranged for generating a first input display data; a compressor, arranged for receiving the first input display data and generating a compressed display data according to the first input display data; and an output interface, arranged for packing the compressed display data into a bitstream, and outputting the bitstream via a display interface. The second data processing apparatus is for driving a display apparatus, and includes an input interface, arranged for receiving the bitstream via the display interface, and un-packing the bitstream into a second input display data; a second controller, arranged for controlling operations of the second data processing apparatus; and a de-compressor, arranged for generating a de-compressed display data according to the second input display data when the second input display data is the compressed display data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a data processing system according to a first embodiment of the present invention.

FIG. 2 is a flowchart illustrating a control and data flow of the data processing system shown in FIG. 1.

FIG. 3 is a block diagram illustrating a data processing system according to a second embodiment of the present invention.

FIG. 4 is a flowchart illustrating a control and data flow of the driver IC shown in FIG. 3.

FIG. 5 is a block diagram illustrating a data processing system according to a third embodiment of the present invention.

FIG. 6 is a flowchart illustrating a control and data flow of the driver IC shown in FIG. 5.

FIG. 7 is a block diagram illustrating a data processing system according to a fourth embodiment of the present invention.

FIG. 8 is a flowchart illustrating a control and data flow of the driver IC shown in FIG. 7.

FIG. 9 is a block diagram illustrating a data processing system according to a fifth embodiment of the present invention.

FIG. 10 is a flowchart illustrating a control and data flow of the driver IC shown in FIG. 9.

FIG. 11 is a block diagram illustrating a data processing system according to a sixth embodiment of the present invention.

FIG. 12 is a flowchart illustrating a control and data flow of the driver IC shown in FIG. 11.

FIG. 13 is a block diagram illustrating a data processing system according to a seventh embodiment of the present invention.

FIG. 14 is a flowchart illustrating a control and data flow of the data processing system shown in FIG. 13.

FIG. 15 is a block diagram illustrating a data processing system according to an eighth embodiment of the present invention.

FIG. 16 is a flowchart illustrating a control and data flow of the data processing system shown in FIG. 15.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The concept of the present invention is to apply data compression upon display data and then transmit compressed display data over a display interface. As the data size/data rate of the compressed display data is smaller than that of the original un-compressed display data, the power consumption of the display interface is reduced correspondingly. Further details will be described as below.

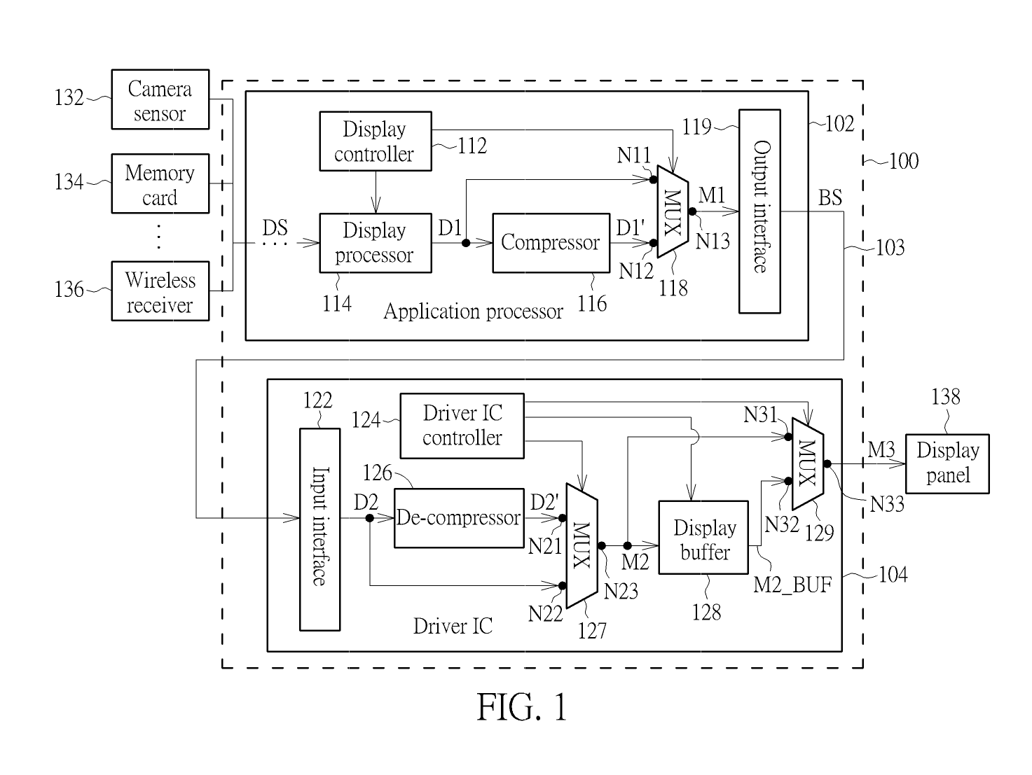

FIG. 1 is a block diagram illustrating a data processing system according to a first embodiment of the present invention. The data processing system 100 includes a plurality of data processing apparatuses such as an application processor 102 and a driver integrated circuit (IC) 104. The application processor 102 and the driver IC 104 may be different chips, and the application processor 102 communicates with the driver IC 104 via a display interface 103. By way of example, but not limitation, the display interface 103 may be a display serial interface (DSI) standardized by a Mobile Industry Processor Interface (MIPI) or an embedded display port (eDP) standardized by a Video Electronics Standards Association (VESA).

The application processor 102 includes, but not limited to, a display controller 112, a display processor 114, a compressor 116, a multiplexer (MUX) 118, and an output interface 119. The display controller 112 is arranged for controlling operations of the application processor 102. For example, the display controller 112 controls the display processor 114 and the multiplexer 118. The display processor 114 receives a source display data DS derived from an output of an external data source such as a camera sensor 132, a memory card 134 or a wireless receiver 136. In one exemplary design, the source display data DS may be directly retrieved from the external data source if no additional image/video processing (i.e., pre-processing) is needed to be applied to the output of the external data source before the output of the external data source arrives at the display processor 114. By way of example, but not limitation, the application processor 102 may be configured to include one or more processing units (not shown) located before the display processor 114. However, under certain operational scenarios, the processing unit(s) may be bypassed such that the source display data DS received by the display processor 114 is identical to the output of the external data source. In another exemplary design, the source display data DS may be a processing result of the output of the external data source if additional image/video processing (i.e., pre-processing) is needed to be applied to the output of an external data source before the output of the external data source arrives at the display processor 114. For example, the output of the external data source is processed by one or more processing units located before the display processor 114. Hence, under certain operational scenarios, the source display data DS received by the display processor 114 is different from the output of the external data source. To put it simply, the present invention has no limitation on the source of the source display data DS received by the display processor 114.

The source display data DS may include image data, video data, graphic data, and/or OSD data. Besides, the source display data DS may be single view data for 2D display or multiple view data for 3D display. After receiving the source display data DS, the display processor 114 performs image processing operations, such as scaling, rotating, etc., upon the source display data DS, and accordingly generates an input display data D1.

The application processor 102 may operate in a normal mode (i.e., a non-compression mode) or a compression mode. As shown in FIG. 1, the multiplexer 118 has a plurality of input ports N11, N12 and an output port N13. The input port N11 is arranged for receiving the input display data D1 generated from the display processor 114. The input port N12 is arranged for receiving a compressed display data D1′ generated from the compressor 116 by applying data compression to the input display data D1. The output port N13 is arranged for selectively outputting the input display data D1 or the compressed display data D1′ to the output interface 119. When the display controller 112 controls the application processor 102 to operate under the normal/non-compression mode, the compressor 116 is disabled or powered off, and the multiplexer 118 selects the input display data D1 as a multiplexer output M1. When the display controller 112 controls the application processor 102 to operate under the compression mode, the compressor 116 is enabled or powered on to receive the input display data D1 and generate the compressed display data D1′ according to the received input display data D1; besides, the multiplexer 118 selects the compressed display data D1′ as the multiplexer output M1. It should be noted that the compressor 116 may employ a lossy or lossless compression algorithm, depending upon actual design consideration/requirement.

The output interface 119 is coupled to the multiplexer 118, and arranged for packing the multiplexer output M1 into a bitstream BS and outputting the bitstream BS to the display interface 103. More specifically, the output interface 119 packetizes the multiplexer output M1 based on the transmission protocol of the display interface 103. As mentioned above, the multiplexer output M1 may be the input display data D1 or the compressed display data D1′. Therefore, when the application processor 102 operates under the normal/non-compression mode, the output interface 119 is operative to convert the input display data D1 into the bitstream BS; and when the application processor 102 operates under the compression mode, the output interface 119 is operative to convert the compressed display data D1′ into the bitstream BS.

The driver IC 104 includes, but not limited to, an input interface 122, a driver IC controller 124, a de-compressor 126, a display buffer 128, and a plurality of multiplexers 127, 129. The driver IC controller 124 is arranged to control operations of the driver IC 104. For example, the driver IC controller 124 controls the display buffer 128 and the multiplexers 127, 129. The driver IC 104 may operate in a normal mode (i.e., a non-decompression mode) or a de-compression mode. That is, when the application processor 102 operates under the normal/non-compression mode, the driver IC controller 124 controls the driver IC 104 to operate under the normal/non-decompression mode; and when the application processor 102 operates under the compression mode, the driver IC controller 124 controls the driver IC 104 to operate under the de-compression mode. In this way, the display data can be correctly received at the driver IC 104.

The input interface 122 is arranged for receiving the bitstream BS via the display interface 103, and un-packing the bitstream BS into an input display data D2. More specifically, the input interface 122 un-packetizes the bitstream BS based on the transmission protocol of the display interface 103. As shown in FIG. 1, the multiplexer 127 has a plurality of input ports N21, N22 and an output port N23. The input port N21 is arranged for receiving a de-compressed display data D2′ generated from the de-compressor 126. The input port N22 is arranged for receiving the input display data D2 generated from the input interface 122. The output port N23 is arranged for selectively outputting the input display data D2 or the de-compressed display data D2′. When the driver IC 104 operates under the normal/non-decompression mode, the input display data D2 is identical to the input display data D1 if no error occurs during the transmission. In addition, the de-compressor 126 is disabled or powered off, and the multiplexer 127 selects the input display data D2 as a multiplexer output M2. When the driver IC 104 operates under the de-compression mode, the input display data D2 is identical to the compressed display data D1′ if no error occurs during the transmission, and the de-compressed display data D2′ is identical to the input display data D1 if lossless compression is applied and no error occurs during data de-compression. In addition, the de-compressor 126 is enabled or powered on to receive the input display data D2 and generate the de-compressed display data D2′ according to the received input display data D2, and the multiplexer 127 selects the de-compressed display data D2′ as the multiplexer output M2.

In this embodiment, the driver IC 104 supports two display modes, including a video mode and an image/command mode, for driving the display panel 138. The video mode means that the display data is directly displayed on the display panel 138 without picture size wise buffering on the transmission path. The image/command mode means that the display data is stored into the display buffer (e.g., a static random access memory (SRAM), a dynamic random access memory (DRAM), or a register file) 128 such that the application processor 102 could issue a command to update only a portion of stored data in the display buffer 128 (i.e., the stored display data is partially updated) to save transmission bandwidth and power dissipation. Hence, when the image/command mode is selected, the display buffer 128 buffers the multiplexer output M2 and outputs a buffered display data M2_BUF; and when the video mode is enabled, the driver IC controller 126 may block the multiplexer output M2 from entering the display buffer 128 or block the buffered display data M2_BUF from being selected as an output of the multiplexer 129. As shown in FIG. 1, the multiplexer 129 has a plurality of input ports N31, N32 and an output port N33. The input port N31 is arranged for receiving the multiplexer output M2 generated from the multiplexer 127. The input port N32 is arranged for receiving the buffered display data M2_BUF provided by the display buffer 128. The output port N13 is arranged for selectively outputting the multiplexer output M2 or the buffered display data M2_BUF as a multiplexer output M3 to the following display panel 138. By way of example, but not limitation, the display panel 138 may be implemented using any 2D/3D display device (e.g. a retina display), and the pixel arrangement may be a rectangle layout, a triangle layout or a pentile layout.

Briefly summarized, the compressor 116 is located between the display processor 114 and the output interface 119, and the de-compressor 126 is located right behind the input interface 122. Hence, the compressor 116 is active only when the compression mode is enabled. Regarding the de-compressor 126, it is active in both video and image/command mode when the compressor 116 is active to generate the compressed display data D1′ to be transmitted over the display interface 103. The multiplexer 118 configures its internal interconnection based on whether or not the compression mode is enabled. The multiplexer 127 configures its internal interconnection based on whether or not the de-compression mode is enabled. The multiplexer 129 configures its internal interconnection based on a selected display mode, either the video mode or the image/command mode. When the compression mode is enabled, the transmission data rate between the application processor 102 and the driver IC 104 is reduced, thus lowering the power consumption of the display interface 103.

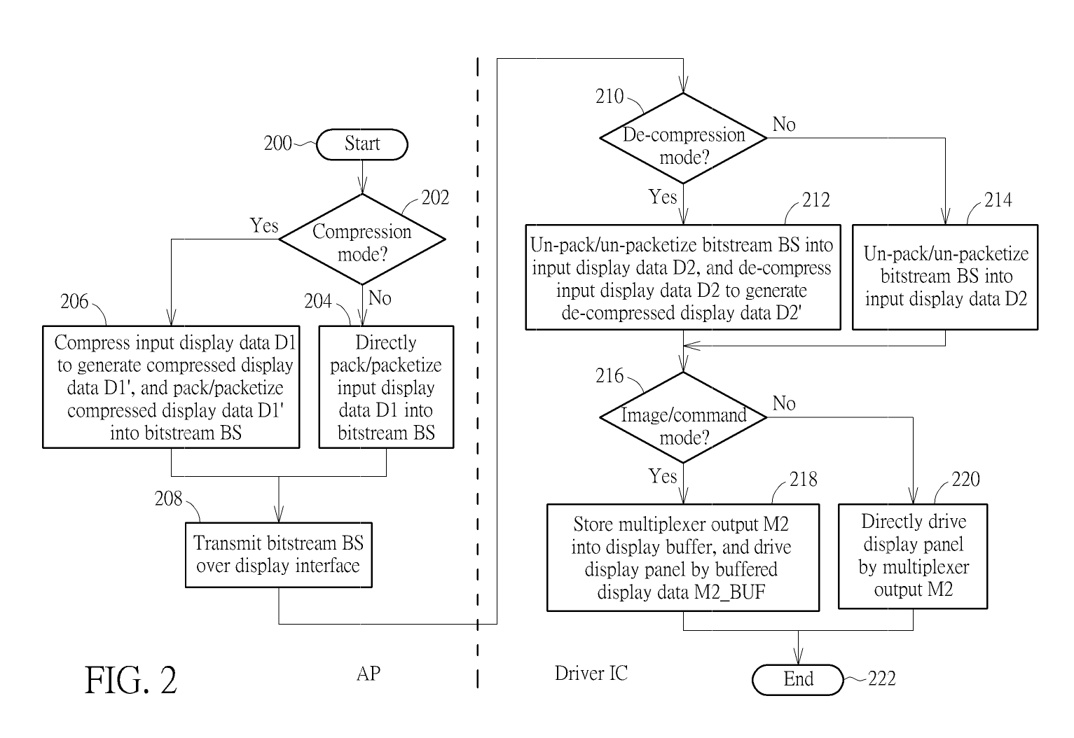

FIG. 2 is a flowchart illustrating a control and data flow of the data processing system 100 shown in FIG. 1. Provided that the result is substantially the same, the steps are not required to be executed in the exact order shown in FIG. 2. The exemplary control and data flow may be briefly summarized by following steps.

Step 200: Start.

Step 202: Check if a compression mode is enabled. If yes, go to step 206; otherwise, go to step 204.

Step 204: Directly pack/packetize the input display data D1 into the bitstream BS. Go to step 208.

Step 206: Compress the input display data D1 to generate the compressed display data D1′, and pack/packetize the compressed display data D1′ into the bitstream BS.

Step 208: Transmit the bitstream BS over the display interface 103.

Step 210: Check if a de-compression mode is enabled. If yes, go to step 212; otherwise, go to step 214.

Step 212: Un-pack/un-packetize the bitstream BS into the input display data D2, and de-compress the input display data D2 to generate the de-compressed display data D2′. Go to step 216.

Step 214: Un-pack/un-packetize the bitstream BS into the input display data D2.

Step 216: Check if the image/command mode is selected for driving the display panel 138. If yes, go to step 218; otherwise, go to step 220.

Step 218: Store the multiplexer output M2 into the display buffer 128 as buffered display data M2_BUF, and drive the display panel 138 by the buffered display data M2_BUF. Go to step 222.

Step 220: Directly drive the display panel 138 by the multiplexer output M2.

Step 222: End.

It should be noted that steps 202-208 are performed by the application processor (AP) 102, and steps 210-220 are performed by the driver IC 104. As a person skilled in the art can readily understand details of each step shown in FIG. 2 after reading above paragraphs directed to the data processing system 100 shown in FIG. 1, further description is omitted here for brevity.

Regarding the data processing system 100 shown in FIG. 1, when data compression is applied to the display data to be transmitted over the display interface 103, the de-compressed display data D2′ is used for driving the display panel 138 no matter whether the selected display mode is the video mode or the image/command mode. However, this is for illustrative purposes only, and is not meant to be a limitation of the present invention. That is, the de-compressor 126 is allowed to be located at a different path within the driver IC. Several alternative designs of the driver IC are given as below.

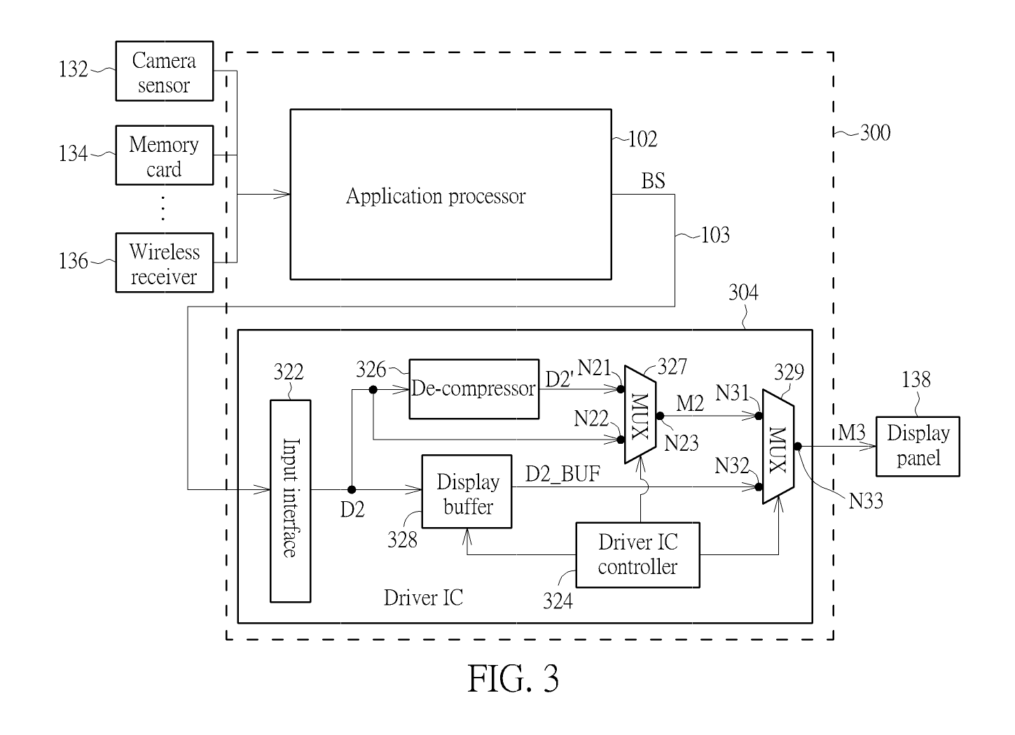

Please refer to FIG. 3, which is a block diagram illustrating a data processing system according to a second embodiment of the present invention. The data processing system 300 includes a plurality of data processing apparatuses such as the aforementioned application processor 102 and a driver IC 304. The application processor 102 and the driver IC 304 may be different chips, and the application processor 102 communicates with the driver IC 304 via the aforementioned display interface 103. In this embodiment, the driver IC 304 includes, but not limited to, an input interface 322, a driver IC controller 324, a de-compressor 326, a display buffer 328, and a plurality of multiplexers 327, 329. The driver IC controller 324 is arranged to control operations of the driver IC 304. For example, the driver IC controller 324 controls the display buffer 328 and the multiplexers 327, 329. Similarly, the driver IC 304 may be controlled to operate in a normal/non-decompression mode or a de-compression mode based on the operational mode employed by the application processor 102. The input interface 322 is arranged for receiving the bitstream BS via the display interface 103, and un-packing the bitstream BS into an input display data D2. More specifically, the input interface 322 un-packetizes the bitstream BS based on the transmission protocol of the display interface 103. As shown in FIG. 3, the input display data D2 may be fed into the de-compressor 326 for data de-compression, stored into the display buffer (e.g., an SRAM, a DRAM, or a register file) 328, or directly bypassed to the multiplexer 327. In this embodiment, the data de-compression is applied to the input display data D2 only when the driver IC 304 operates under the de-compression mode and the video mode is selected for driving the display panel 138.

As shown in FIG. 3, the multiplexer 327 has a plurality of input ports N21, N22 and an output port N23. The input port N21 is arranged for receiving a de-compressed display data D2′ generated from the de-compressor 326 by applying data de-compression to the input display data D2. The input port N22 is arranged for receiving the input display data D2 generated from the input interface 322. The output port N23 is arranged for selectively outputting the input display data D2 or the de-compressed display data D2′ as a multiplexer output M2.

Regarding the multiplexer 329 shown in FIG. 3, it has a plurality of input ports N31, N32 and an output port N33. The input port N31 is arranged for receiving the multiplexer output M2 generated from the multiplexer 327. The input port N32 is arranged for receiving the input display data D2 stored in the display buffer 328 (i.e., the buffered display data D2_BUF provided by the display buffer 328). The output port N33 is arranged for selectively outputting the multiplexer output M2 or the buffered display data D2_BUF as a multiplexer output M3 to the following display panel 138.

In a case where the driver IC 304 is controlled to operate under the normal/non-decompression mode, the input display data D2 is identical to the input display data D1 shown in FIG. 1 if no error occurs during the transmission. In addition, the de-compressor 126 is disabled or powered off since no data de-compression is needed when the display mode is set by either of the video mode and the image/command mode. When the video mode is selected for driving the display panel 138, the multiplexer 327 selects the input display data D2 as the multiplexer output M2, and the multiplexer 329 selects the multiplexer output M2 as the multiplexer output M3. When the image/command mode is selected for driving the display panel 138, the input display data D2 is stored into the display buffer 328, and the multiplexer 329 selects the buffered display data D2_BUF as the multiplexer output M3.

In another case where the driver IC 304 is controlled to operate under the de-compression mode, the de-compressor 326 is enabled or powered on. The input display data D2 is identical to the compressed input display data D1′ shown in FIG. 1 if no error occurs during the transmission, and the de-compressed display data D2′ is identical to the input display data D1 shown in FIG. 1 if lossless compression is applied and no error occurs during data de-compression. It should be noted that only the video mode is allowed to be selected for driving the display panel 138 when the driver IC 304 operates under the de-compression mode in this embodiment. Hence, the multiplexer 327 selects the de-compressed display data D2′ as the multiplexer output M2, and the multiplexer 329 selects the multiplexer output M2 as the multiplexer output M3.

Briefly summarized, the de-compressor 326 and the display buffer 328 are connected in a parallel fashion. Hence, the display buffer 328 stores un-compressed display data for image/command mode only, and the de-compressor 326 is active in the video mode only. The multiplexer 327 configures its internal interconnection based on whether or not the data de-compression is needed when the video mode is selected for driving the display panel 138. The multiplexer 329 configures its internal interconnection based on a selected display mode, either the video mode or the image/command mode. When the compression mode is enabled by the application processor 102, the transmission data rate between the application processor 102 and the driver IC 304 is reduced, thus lowering the power consumption of the display interface 103.

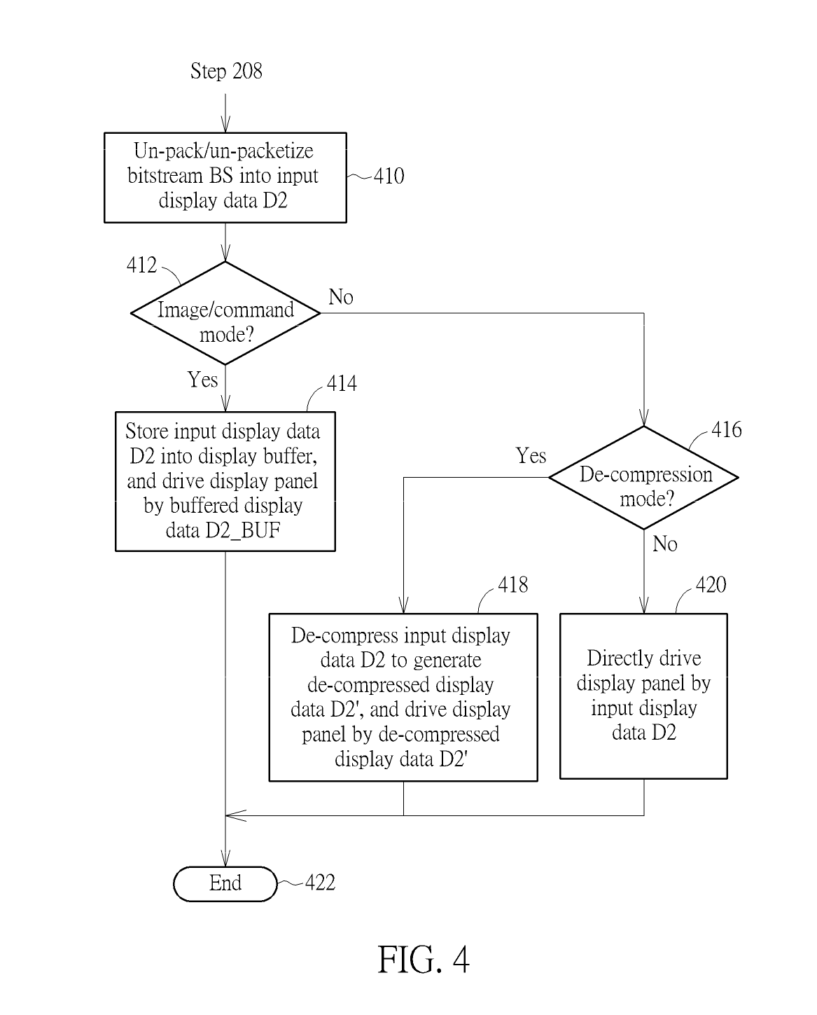

FIG. 4 is a flowchart illustrating a control and data flow of the driver IC 304 shown in FIG. 3. Provided that the result is substantially the same, the steps are not required to be executed in the exact order shown in FIG. 3. The steps 202-208 shown in FIG. 2 are also performed by the application processor 102 shown in FIG. 3. Hence, only the steps performed by the driver IC 304 are shown in FIG. 4 for simplicity. The exemplary control and data flow of the driver IC 304 may be briefly summarized by following steps.

Step 410: Un-pack/un-packetize the bitstream BS into the input display data D2.

Step 412: Check if the image/command mode is selected for driving the display panel 138. If yes, go to step 414; otherwise, go to step 416.

Step 414: Store the input display data D2 into the display buffer 328, and drive the display panel 138 by the buffered display data D2_BUF. Go to step 422.

Step 416: Check if the de-compression mode is enabled. If yes, go to step 418; otherwise, go to step 420.

Step 418: De-compress the input display data D2 to generate the de-compressed display data D2′, and drive the display panel 138 by the de-compressed display data D2′. Go to step 422.

Step 420: Directly drive the display panel 138 by the input display data D2.

Step 422: End.

As a person skilled in the art can readily understand details of each step shown in FIG. 4 after reading above paragraphs directed to the data processing system 300 shown in FIG. 3, further description is omitted here for brevity.

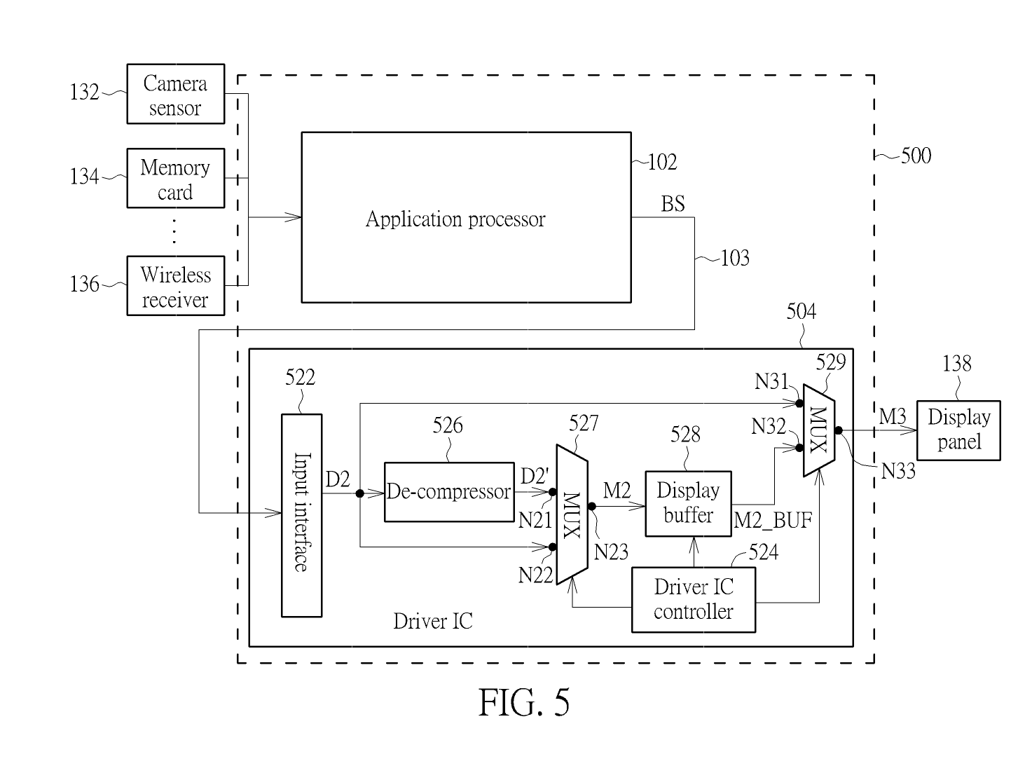

Please refer to FIG. 5, which is a block diagram illustrating a data processing system according to a third embodiment of the present invention. The data processing system 500 includes a plurality of data processing apparatuses such as the aforementioned application processor 102 and a driver IC 504. The application processor 102 and the driver IC 504 may be different chips, and the application processor 102 communicates with the driver IC 504 via the aforementioned display interface 103. In this embodiment, the driver IC 504 includes, but not limited to, an input interface 522, a driver IC controller 524, a de-compressor 526, a display buffer 528, and a plurality of multiplexers 527, 529. The driver IC controller 524 is arranged to control operations of the driver IC 504. For example, the driver IC controller 524 controls the display buffer 528 and the multiplexers 527, 529. Similarly, the driver IC 504 may operate in the normal/non-decompression mode or a de-compression mode based on the operational mode employed by the application processor 102. The input interface 522 is arranged for receiving the bitstream BS via the display interface 103, and un-packing the bitstream BS into an input display data D2. More specifically, the input interface 522 un-packetizes the bitstream BS based on the transmission protocol of the display interface 103. As shown in FIG. 5, the input display data D2 may be fed into the de-compressor 526 for data de-compression, directly bypassed to the multiplexer 527, or directly bypassed to the multiplexer 529. In this embodiment, the data de-compression is applied to the input display data D2 only when the driver IC 304 operates under the de-compression mode and the image/command mode is selected for driving the display panel 138.

As shown in FIG. 5, the multiplexer 527 has a plurality of input ports N21, N22 and an output port N23. The input port N21 is arranged for receiving a de-compressed display data D2′ generated from the de-compressor 526 by applying data de-compression to the input display data D2. The input port N22 is arranged for receiving the input display data D2 generated from the input interface 522. The output port N23 is arranged for selectively outputting the input display data D2 or the de-compressed display data D2′ as a multiplexer output M2.

Regarding the multiplexer 529 shown in FIG. 5, it has a plurality of input ports N31, N32 and an output port N33. The input port N31 is arranged for receiving the input display data D2 generated from the input interface 522. The input port N32 is arranged for receiving the multiplexer output M2 stored in the display buffer 528 (i.e., the buffered display data M2_BUF provided by the display buffer 528). The output port N33 is arranged for selectively outputting the input display data D2 or the buffered display data M2_BUF as a multiplexer output M3 to the following display panel 138.

In a case where the driver IC 504 is controlled to operate under the normal/non-decompression mode, the input display data D2 is identical to the input display data D1 shown in FIG. 1 if no error occurs during the transmission. In addition, the de-compressor 526 is disabled or powered off since no data de-compression is needed when the display mode is set by either of video mode and image/command mode. When the video mode is selected for driving the display panel 138, the multiplexer 529 selects the input display data D2 as the multiplexer output M3. When the image/command mode is selected for driving the display panel 138, the multiplexer 527 selects the input display data D2 as the multiplexer output M2, the multiplexer output M2 is stored into the display buffer 528, and the multiplexer 329 selects the buffered display data M2_BUF as the multiplexer output M3.

In another case where the driver IC 504 is controlled to operate under the de-compression mode, the de-compressor 526 is enabled or powered on. The input display data D2 is identical to the compressed input display data D1′ shown in FIG. 1 if no error occurs during the transmission, and the de-compressed display data D2′ is identical to the input display data D1 shown in FIG. 1 if lossless compression is applied and no error occurs during data de-compression. It should be noted that only the image/command mode is allowed to be selected for driving the display panel 138 when the driver IC 504 operates under the de-compression mode in this embodiment. Hence, the multiplexer 527 selects the de-compressed display data D2′ as the multiplexer output M2, and the multiplexer 329 selects the buffered display output M2_BUF as the multiplexer output M3.

Briefly summarized, the display buffer 528 stores un-compressed display data or de-compressed display data for image/command mode, and the de-compressor 326 is active in the image/command mode only. The multiplexer 527 configures its internal interconnection based on whether or not the data de-compression is needed when the image/command mode is selected for driving the display panel 138. The multiplexer 529 configures its internal interconnection based on the selected display mode, either the video mode or the image/command mode. When the compression mode is enabled by the application processor 102, the transmission data rate between the application processor 102 and the driver IC 504 is reduced, thus lowering the power consumption of the display interface 103.

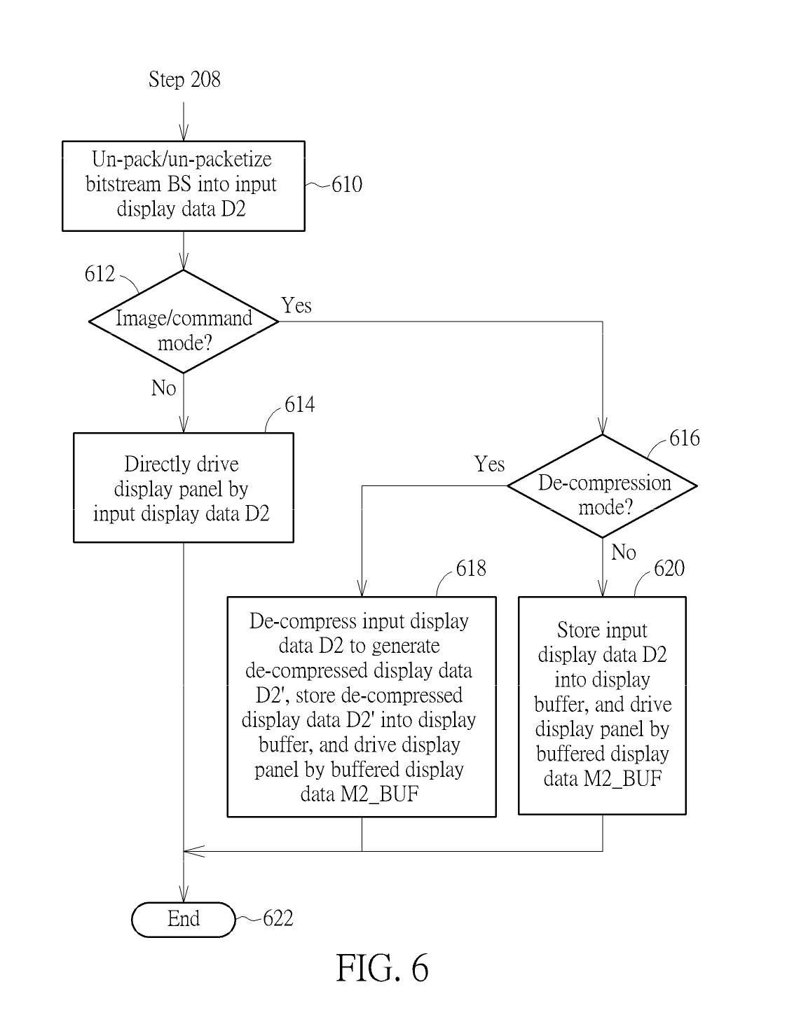

FIG. 6 is a flowchart illustrating a control and data flow of the driver IC 504 shown in FIG. 5. Provided that the result is substantially the same, the steps are not required to be executed in the exact order shown in FIG. 5. The steps 202-208 shown in FIG. 2 are also performed by the application processor 102 shown in FIG. 5. Hence, only the steps performed by the driver IC 504 are shown in FIG. 6 for simplicity. The exemplary control and data flow of the driver IC 504 may be briefly summarized by following steps.

Step 610: Un-pack/un-packetize the bitstream BS into the input display data D2.

Step 612: Check if the image/command mode is selected for driving the display panel 138. If yes, go to step 616; otherwise, go to step 614.

Step 614: Directly drive the display panel 138 by the input display data D2.

Step 616: Check if the de-compression mode is enabled. If yes, go to step 618; otherwise, go to step 620.

Step 618: De-compress the input display data D2 to generate the de-compressed display data D2′, store the de-compressed display data D2′ into the display buffer 528, and drive the display panel 138 by the buffered display data M2_BUF. Go to step 622.

Step 620: Store the input display data D2 into the display buffer 528, and drive the display panel 138 by the buffered display data M2_BUF.

Step 622: End.

As a person skilled in the art can readily understand details of each step shown in FIG. 6 after reading above paragraphs directed to the data processing system 500 shown in FIG. 5, further description is omitted here for brevity.

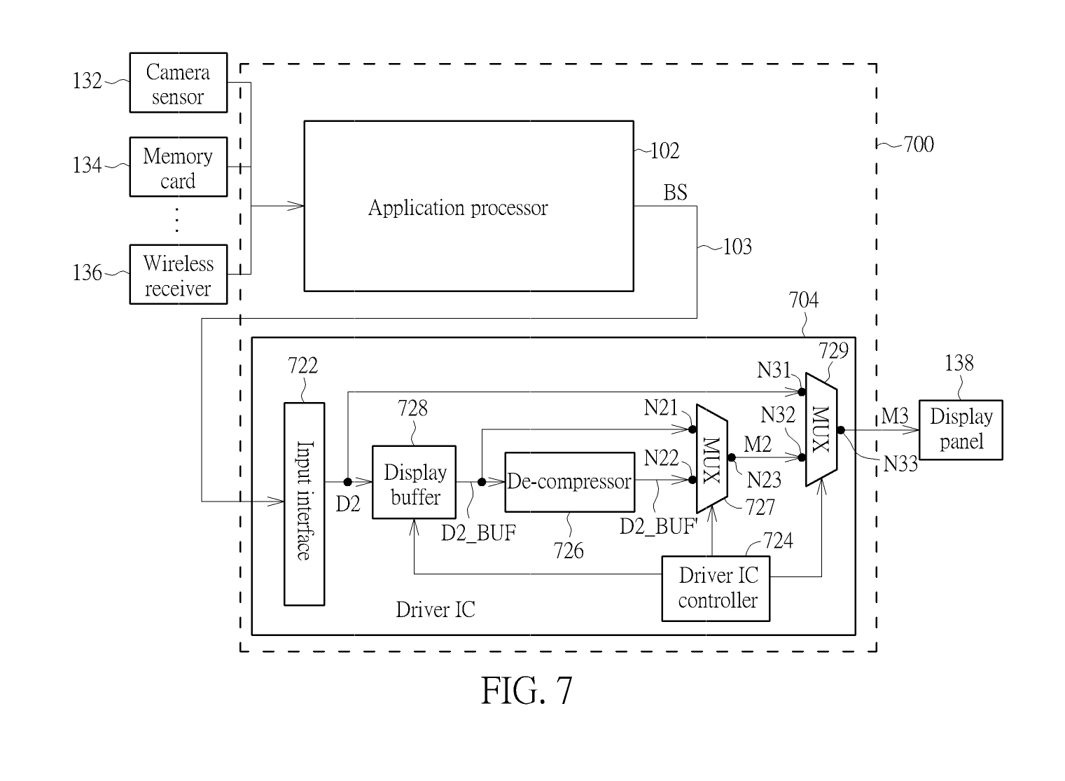

Please refer to FIG. 7, which is a block diagram illustrating a data processing system according to a fourth embodiment of the present invention. The data processing system 700 includes a plurality of data processing apparatuses such as the aforementioned application processor 102 and a driver IC 704. The application processor 102 and the driver IC 704 may be different chips, and the application processor 102 communicates with the driver IC 704 via the aforementioned display interface 103. In this embodiment, the driver IC 704 includes, but not limited to, an input interface 722, a driver IC controller 724, a de-compressor 726, a display buffer 728, and a plurality of multiplexers 727, 729. The driver IC controller 724 is arranged to control operations of the driver IC 704. For example, the driver IC controller 724 controls the display buffer 728 and the multiplexers 727, 729. Similarly, the driver IC 704 may operate in the normal/non-decompression mode or a de-compression mode based on the operational mode employed by the application processor 102. The input interface 722 is arranged for receiving the bitstream BS via the display interface 103, and un-packing the bitstream BS into an input display data D2. More specifically, the input interface 722 un-packetizes the bitstream BS based on the transmission protocol of the display interface 103. As shown in FIG. 7, the input display data D2 may be fed into the display buffer 728 or directly bypassed to the multiplexer 729. More specifically, the data de-compression is applied to the input display data D2 stored into the display buffer 728 (i.e., the buffered display data D2_BUF) only when the driver IC 704 operates under the de-compression mode and the image/command mode is selected for driving the display panel 138.

As shown in FIG. 7, the multiplexer 727 has a plurality of input ports N21, N22 and an output port N23. The input port N21 is arranged for receiving the buffered display data D2_BUF provided by the display buffer 728. The second port N22 is arranged for receiving a de-compressed display data D2_BUF′ generated from the de-compressor 726 by applying data de-compression to the buffered display data D2_BUF. The output port N23 is arranged for selectively outputting the buffered display data D2_BUF or the de-compressed display data D2_BUF′ as a multiplexer output M2.

Regarding the multiplexer 729 shown in FIG. 7, it has a plurality of input ports N31, N32 and an output port N33. The input port N31 is arranged for receiving the input display data D2 generated from the input interface 722. The input port N32 is arranged for receiving the multiplexer output M2. The output port N33 is arranged for selectively outputting the input display data D2 or the multiplexer output M2 as a multiplexer output M3 to the following display panel 138.

In a case where the driver IC 704 is controlled to operate under the normal/non-decompression mode, the input display data D2 is identical to the input display data D1 shown in FIG. 1 if no error occurs during the transmission. In addition, the de-compressor 726 is disabled or powered off since no data de-compression is needed when the display mode is set by either of the video mode and the image/command mode. When the video mode is selected for driving the display panel 138, the multiplexer 729 selects the input display data D2 as the multiplexer output M3. When the image/command mode is selected for driving the display panel 138, the multiplexer 727 selects the buffered display data D2_BUF as the multiplexer output M2, and the multiplexer 729 selects the multiplexer output M2 as the multiplexer output M3.

In another case where the driver IC 704 is controlled to operate under the de-compression mode, the de-compressor 726 is enabled or powered on. The input display data D2 is identical to the compressed input display data D1′ shown in FIG. 1 if no error occurs during the transmission, and the de-compressed display data D2_BUF′ is identical to the input display data D1 shown in FIG. 1 if lossless compression is applied and no error occurs during data de-compression and data buffering. It should be noted that only the image/command mode is allowed to be selected for driving the display panel 138 when the driver IC 704 operates under the de-compression mode in this embodiment. Hence, the multiplexer 727 selects the de-compressed display data D2_BUF′ as the multiplexer output M2, and the multiplexer 729 selects the multiplexer output M2 as the multiplexer output M3.

Briefly summarized, the display buffer 728 stores un-compressed display data or compressed display data for image/command mode, and the de-compressor 726 is active in the image/command mode only. The multiplexer 727 configures its internal interconnection based on whether or not the data de-compression is needed when the image/command mode is selected for driving the display panel 138. The multiplexer 729 configures its internal interconnection based on the selected display mode, either the video mode or the image/command mode. When the compression mode is enabled by the application processor 102, the transmission data rate between the application processor 102 and the driver IC 504 is reduced, thus lowering the power consumption of the display interface 103.

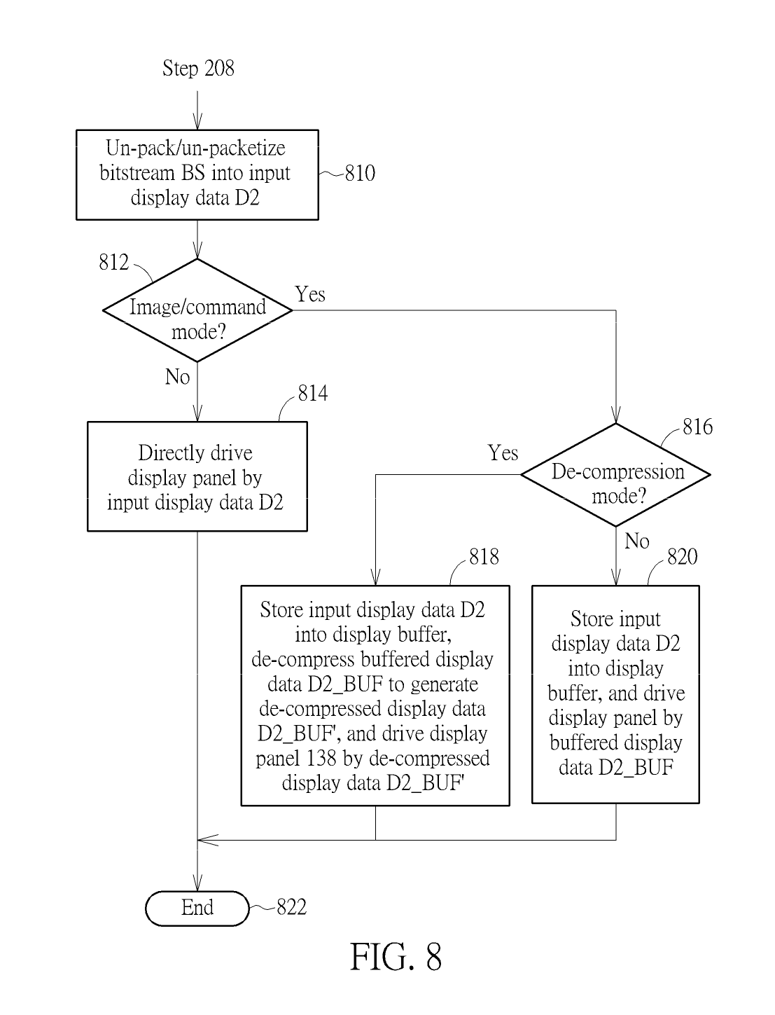

FIG. 8 is a flowchart illustrating a control and data flow of the driver IC 704 shown in FIG. 7. Provided that the result is substantially the same, the steps are not required to be executed in the exact order shown in FIG. 8. The steps 202-208 shown in FIG. 2 are also performed by the application processor 102 shown in FIG. 7. Hence, only the steps performed by the driver IC 704 are shown in FIG. 8 for simplicity. The exemplary control and data flow of the driver IC 704 may be briefly summarized by following steps.

Step 810: Un-pack/un-packetize the bitstream BS into the input display data D2.

Step 812: Check if the image/command mode is selected for driving the display panel 138. If yes, go to step 816; otherwise, go to step 814.

Step 814: Directly drive the display panel 138 by the input display data D2. Go to step 822.

Step 816: Check if the de-compression mode is enabled. If yes, go to step 818; otherwise, go to step 820.

Step 818: Store the input display data D2 into the display buffer 728, de-compress the buffered display data D2_BUF to generate the de-compressed display data D2_BUF′, and drive the display panel 138 by the de-compressed display data D2_BUF′. Go to step 822.

Step 820: Store the input display data D2 into the display buffer 728, and drive the display panel 138 by the buffered display data D2_BUF.

Step 822: End.

As a person skilled in the art can readily understand details of each step shown in FIG. 8 after reading above paragraphs directed to the data processing system 700 shown in FIG. 7, further description is omitted here for brevity.

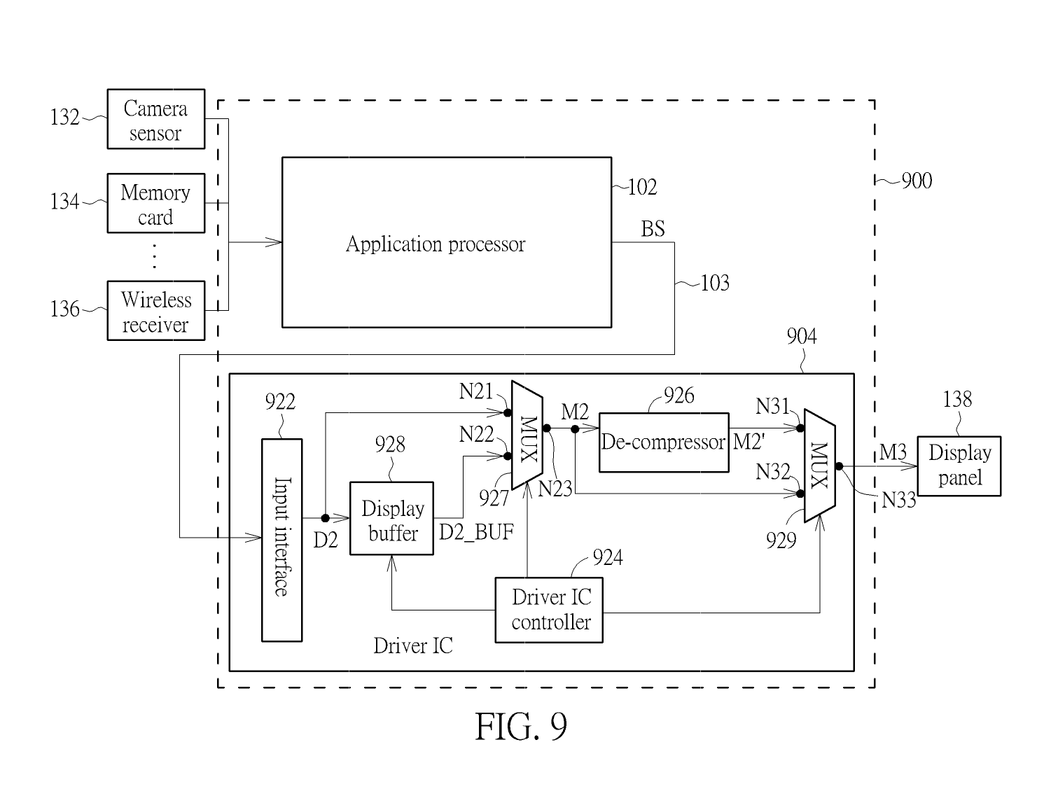

Please refer to FIG. 9, which is a block diagram illustrating a data processing system according to a fifth embodiment of the present invention. The data processing system 900 includes a plurality of data processing apparatuses such as the aforementioned application processor 102 and a driver IC 904. The application processor 102 and the driver IC 904 may be different chips, and the application processor 102 communicates with the driver IC 904 via the aforementioned display interface 103. In this embodiment, the driver IC 904 includes, but not limited to, an input interface 922, a driver IC controller 924, a de-compressor 926, a display buffer 928, and a plurality of multiplexers 927, 929. The driver IC controller 924 is arranged to control operations of the driver IC 904. For example, the driver IC controller 924 controls the display buffer 928 and the multiplexers 927, 929. Similarly, the driver IC 904 may operate in the normal/non-decompression mode or the de-compression mode based on the operational mode employed by the application processor 102. The input interface 922 is arranged for receiving the bitstream BS via the display interface 103, and un-packing the bitstream BS into an input display data D2. More specifically, the input interface 922 un-packetizes the bitstream BS based on the transmission protocol of the display interface 103. As shown in FIG. 9, the input display data D2 may be fed into the display buffer 928 or directly bypassed to the multiplexer 927. In this embodiment, the data de-compression is applied to the input display data D2 or the input display data D2 stored in the display buffer 928 (i.e., a buffered display data D2_BUF).

As shown in FIG. 9, the multiplexer 927 has a plurality of input ports N21, N22 and an output port N23. The input port N21 is arranged for receiving the input display data D2 generated from the input interface 922. The input port N22 is arranged for receiving the buffered display data D2_BUF provided by the display buffer 928. The output port N23 is arranged for selectively outputting the input display data D2 or the buffered display data D2_BUF as a multiplexer output M2.

Regarding the multiplexer 929 shown in FIG. 9, it has a plurality of input ports N31, N32 and an output port N33. The input port N31 is arranged for receiving a de-compressed display data M2′ generated from the de-compressor 926 by applying data de-compression to the multiplexer output M2. The input port N32 is arranged for receiving the multiplexer output M2. The output port N33 is arranged for selectively outputting the multiplexer output M2 or the de-compressed display data M2′ as a multiplexer output M3 to the following display panel 138.

In a case where the driver IC 904 is controlled to operate under the normal/non-decompression mode, the input display data D2 is identical to the input display data D1 shown in FIG. 1 if no error occurs during the transmission. In addition, the de-compressor 926 is disabled or powered off since no data de-compression is needed when the display mode is set by either of the video mode and the image/command mode. When the video mode is selected for driving the display panel 138, the multiplexer 927 selects the input display data D2 as the multiplexer output M2, and the multiplexer 929 selects the multiplexer output M2 as the multiplexer output M3. When the image/command mode is selected for driving the display panel 138, the multiplexer 927 selects the input display data D2 stored in the display buffer 928 (i.e., the buffered display data D2_BUF provided by the display buffer 928) as the multiplexer output M2, and the multiplexer 929 selects the multiplexer output M2 as the multiplexer output M3.

In another case where the driver IC 904 is controlled to operate under the de-compression mode, the de-compressor 926 is enabled or powered on. The input display data D2 is identical to the compressed input display data D1′ shown in FIG. 1 if no error occurs during the transmission, and the de-compressed display data M2′ is identical to the input display data D1 shown in FIG. 1 if lossless compression is applied and no error occurs during data -decompression and/or data buffering. When the video mode is selected for driving the display panel 138, the multiplexer 927 selects the input display data D2 as the multiplexer output M2, and the multiplexer 929 selects the de-compressed display data M2′ generated from applying data de-compression to the multiplexer output M2 as the multiplexer output M3. When the image/command mode is selected for driving the display panel 138, the multiplexer 927 selects the buffered display data D2_BUF as the multiplexer output M2, and the multiplexer 929 selects the de-compressed display data M2′ as the multiplexer output M3.

Briefly summarized, the display buffer 928 stores compressed display data for image/command mode, and the de-compressor 926 is active in both of video mode and image/command mode. The multiplexer 927 configures its internal interconnection based on the selected display mode, either the video mode or the image/command mode. The multiplexer 929 configures its internal interconnection based on whether or not the data de-compression is needed. When the compression mode is enabled by the application processor 102, the transmission data rate between the application processor 102 and the driver IC 904 is reduced, thus lowering the power consumption of the display interface 103.

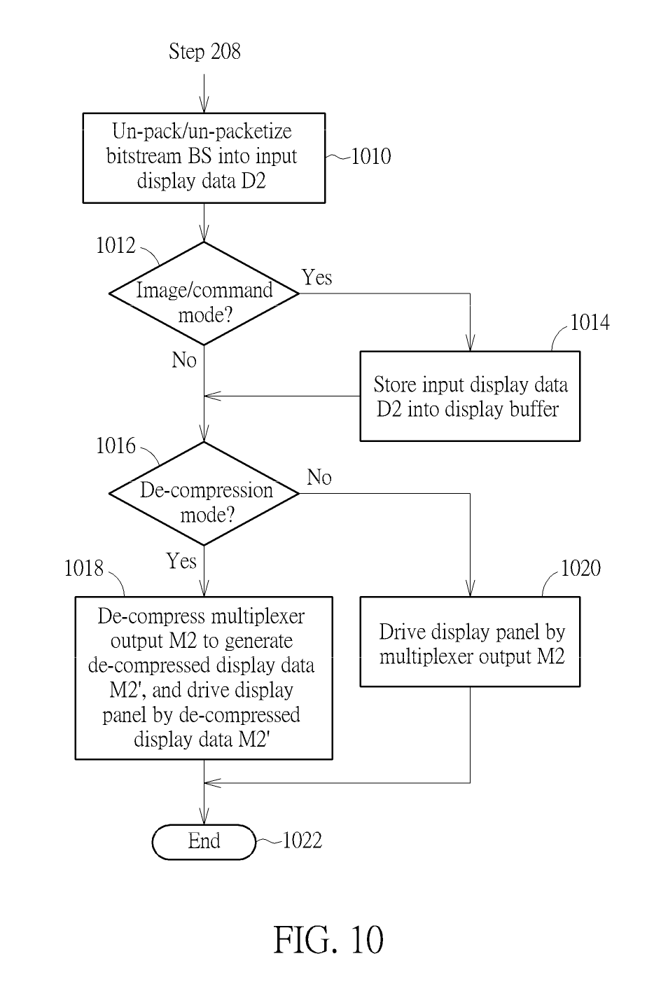

FIG. 10 is a flowchart illustrating a control and data flow of the driver IC 904 shown in FIG. 9. Provided that the result is substantially the same, the steps are not required to be executed in the exact order shown in FIG. 10. The steps 202-208 shown in FIG. 2 are also performed by the application processor 102 shown in FIG. 9. Hence, only the steps performed by the driver IC 904 are shown in FIG. 10 for simplicity. The exemplary control and data flow of the driver IC 904 may be briefly summarized by following steps.

Step 1010: Un-pack/un-packetize the bitstream BS into the input display data D2.

Step 1012: Check if the image/command mode is selected for driving the display panel 138. If yes, go to step 1014; otherwise, go to step 1016.

Step 1014: Store the input display data D2 into the display buffer 928.

Step 1016: Check if the de-compression mode is enabled. If yes, go to step 1018; otherwise, go to step 1020.

Step 1018: De-compress the multiplexer output M2 to generate the de-compressed display data M2′, and drive the display panel 138 by the de-compressed display data M2′. Go to step 1022.

Step 1020: Drive the display panel 138 by the multiplexer output M2.

Step 1022: End.

As a person skilled in the art can readily understand details of each step shown in FIG. 10 after reading above paragraphs directed to the data processing system 900 shown in FIG. 9, further description is omitted here for brevity.

In above exemplary implementation of the driver IC, the driver IC is designed to support both of the video mode and the image/command mode. As the image/command mode may be selected for driving the display panel, the driver IC is required to have a display buffer included therein. As a result, the production cost of the driver IC is increased due to the display buffer. In an alternative design, a low-cost solution may be adopted to use a buffer-less driver IC in the data processing system. As no display buffer is available in the driver IC, the driver IC supports the video mode only.

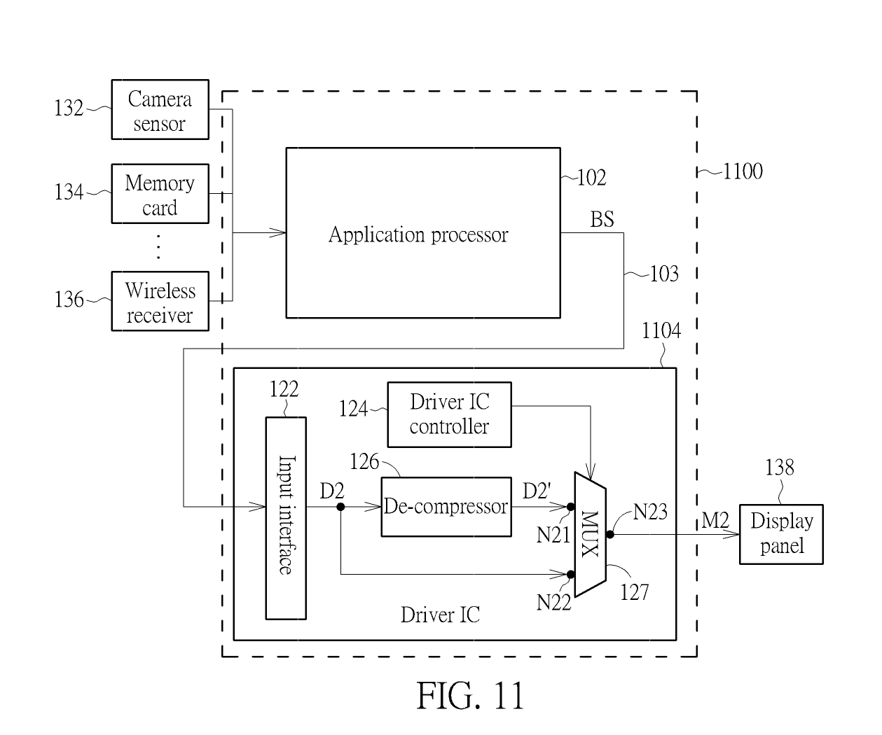

Please refer to FIG. 11, which is a block diagram illustrating a data processing system according to a sixth embodiment of the present invention. The data processing system 1100 includes a plurality of data processing apparatuses such as the aforementioned application processor 102 and a driver IC 1104. The application processor 102 and the driver IC 1104 may be different chips, and the application processor 102 communicates with the driver IC 1104 via the aforementioned display interface 103. In this embodiment, the driver IC 1104 includes the aforementioned input interface 122, driver IC controller 124, de-compressor 126, and multiplexer 127, where the multiplexer output M2 is sent to the display panel 138. When the driver IC 1104 is controlled to operate under the normal/non-decompression mode, the de-compressor 926 is disabled or powered off, and the multiplexer 127 selects the input display data D2 as the multiplexer output M2. When the driver IC 1104 is controlled to operate under the de-compression mode, the de-compressor 926 is enabled or powered on, and the multiplexer 127 selects the de-compressed display data D2′ as the multiplexer output M2.

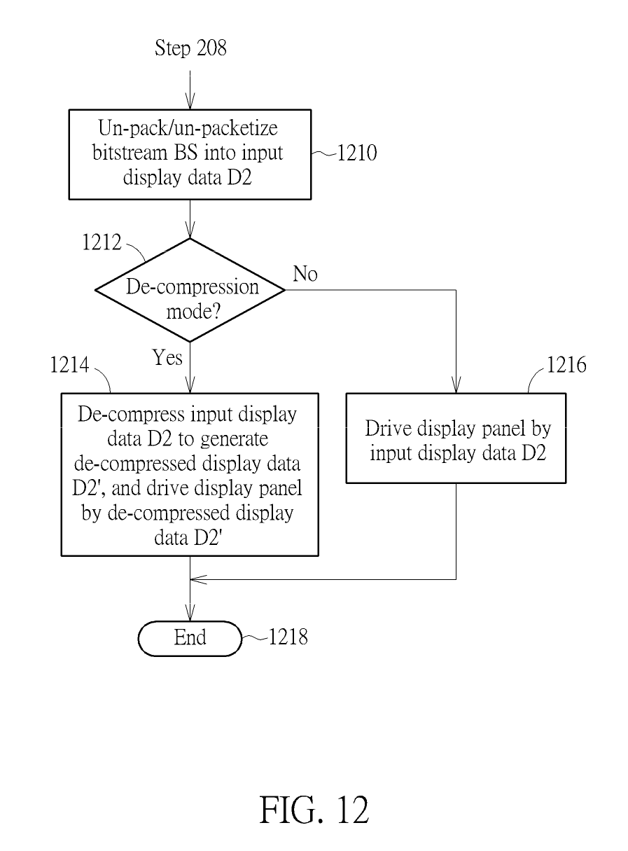

FIG. 12 is a flowchart illustrating a control and data flow of the driver IC 1104 shown in FIG. 11. Provided that the result is substantially the same, the steps are not required to be executed in the exact order shown in FIG. 12. The steps 202-208 shown in FIG. 2 are also performed by the application processor 102 shown in FIG. 11. Hence, only the steps performed by the driver IC 1104 are shown in FIG. 12 for simplicity. The exemplary control and data flow of the driver IC 1104 may be briefly summarized by following steps.

Step 1210: un-pack/un-packetize the bitstream BS into the input display data D2.

Step 1212: Check if the de-compression mode is enabled. If yes, go to step 1214; otherwise, go to step 1216.

Step 1214: De-compress the input display data D2 to generate the de-compressed display data D2′, and drive the display panel 138 by the de-compressed display data D2′. Go to step 1218.

Step 1216: Drive the display panel 138 by the input display data D2.

Step 1218: End.

As a person skilled in the art can readily understand details of each step shown in FIG. 12 after reading above paragraphs directed to the data processing systems 100 and 900, further description is omitted here for brevity.

In above exemplary implementation of the application processor, the application processor is designed to have a compressor included therein to support data compression. However, this is for illustrative purposes only, and is not meant to be a limitation of the present invention. In an alternative design, the compressor may be implemented in a bridge IC located between a preceding application processor and a following driver IC.

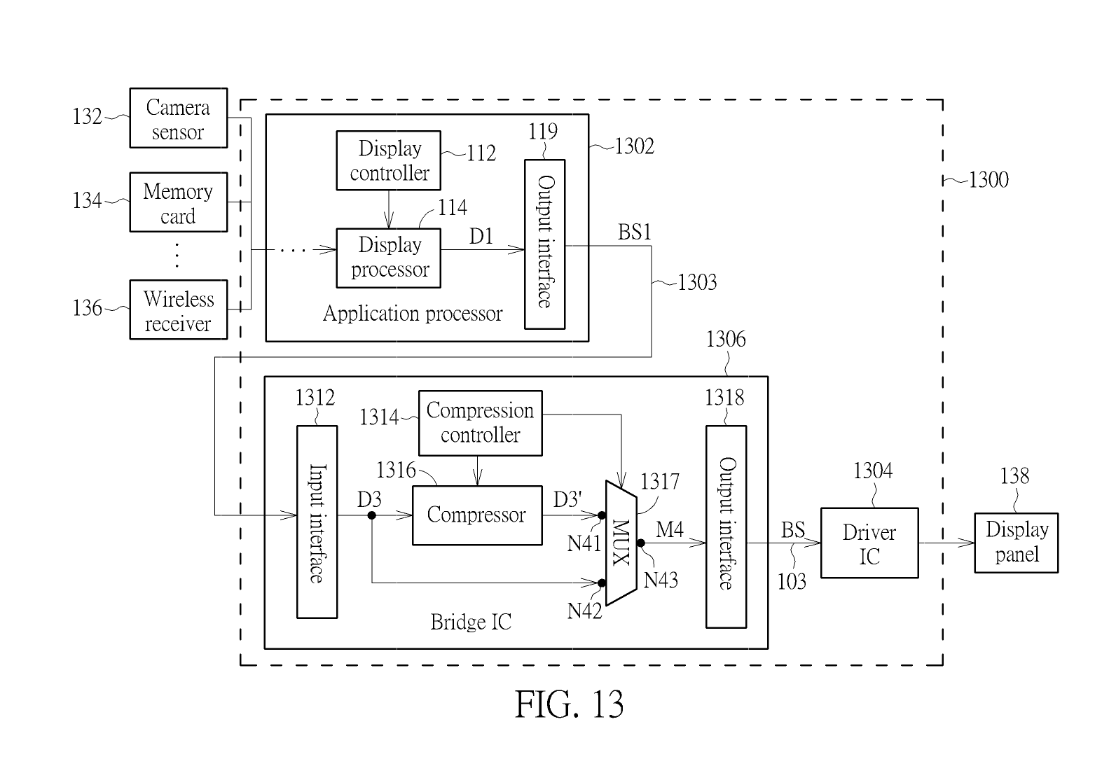

Please refer to FIG. 13, which is a block diagram illustrating a data processing system according to a seventh embodiment of the present invention. The data processing system 1300 includes a plurality of data processing apparatuses such as an application processor 1302, a driver IC 1304 and a bridge IC 1306. The application processor 1302, the driver IC 1304 and the bridge IC 1306 may be different chips, where the application processor 102 communicates with the bridge IC 1306 via a display interface 1303, and the bridge IC 1306 communicates with the driver IC 1304 via the aforementioned display interface 103. By way of example, but not limitation, the display interface 1303 may be a display serial interface (DSI) standardized by a Mobile Industry Processor Interface (MIPI) or an embedded display port (eDP) standardized by a Video Electronics Standards Association (VESA).

The application processor 1302 includes the aforementioned display controller 112, display processor 114 and output interface 119. Thus, the application processor 1302 is arranged for generating an input display data D1, packing/packetizing the input display data D1 into a bitstream BS1, and outputting the bitstream BS1 via the display interface 1303.

In this embodiment, the bridge IC 1306 is coupled between the application processor 1302 and the driver IC 1304, and includes, but not limited to, an input interface 1312, a compression controller 1314, a compressor 1316, a multiplexer 1317, and an output interface 1318. The compression controller 1314 is arranged to control operations of the bridge IC 1306. For example, the compression controller 1314 controls the compressor 1316 and the multiplexer 1317. The bridge IC 1306 may operate in a normal/non-compression mode or a compression mode. The input interface 1312 is arranged for receiving the bitstream BS1 via the display interface 1303, and un-packing the bitstream BS into an input display data D3. More specifically, the input interface 1322 un-packetizes the bitstream BS1 based on the transmission protocol of the display interface 1303.

As shown in FIG. 13, the multiplexer 1317 has a plurality of input ports N41, N42 and an output port N43. The input port N41 is arranged for receiving a compressed display data D3′ generated from the compressor 1316 by applying data compression to the input display data D3. The input port N42 is arranged for receiving the input display data D3 generated from the input interface 1312. The output port N43 is arranged for selectively outputting the input display data D3 or the compressed display data D3′ as a multiplexer output M4. When the compression controller 1314 controls the bridge IC 1306 to operate under the normal/non-compression mode, the compressor 1316 is disabled or powered off, and the multiplexer 1317 selects the input display data D3 as the multiplexer output M4 to the following output interface 1318. When the compression controller 1314 controls the bridge IC 1306 to operate under the compression mode, the compressor 1316 is enabled or powered on to receive the input display data D3 and generate the compressed display data D3′ according to the received input display data D3, and the multiplexer 1317 selects the compressed display data D3′ as the multiplexer output M4 to the following output interface 1318. It should be noted that the compressor 1316 may employ a lossy or lossless compression algorithm, depending upon actual design consideration/requirement. The output interface 1318 is arranged for packing the multiplexer output M4 into a bitstream BS and outputting the bitstream BS via the display interface 103. More specifically, the output interface 1318 packetizes the multiplexer output M4 based on the transmission protocol of the display interface 103.

The driver IC 1304 is arranged for receiving the bitstream BS via the display interface 103, and driving the display panel 138 according to display data carried by the bitstream BS. It should be noted that the driver IC 1304 may be implemented using one of the aforementioned driver ICs 104, 304, 504, 704, 904, and 1104. Further description is omitted here for brevity.

As the bridge IC 1306 is equipped with data compression capability, the application processor 1302 is allowed to be implemented using any compressor-free application processor. The same objective of reducing the transmission data rate over a display interface (e.g., 103) between an application processor and a driver IC for power consumption reduction is achieved.

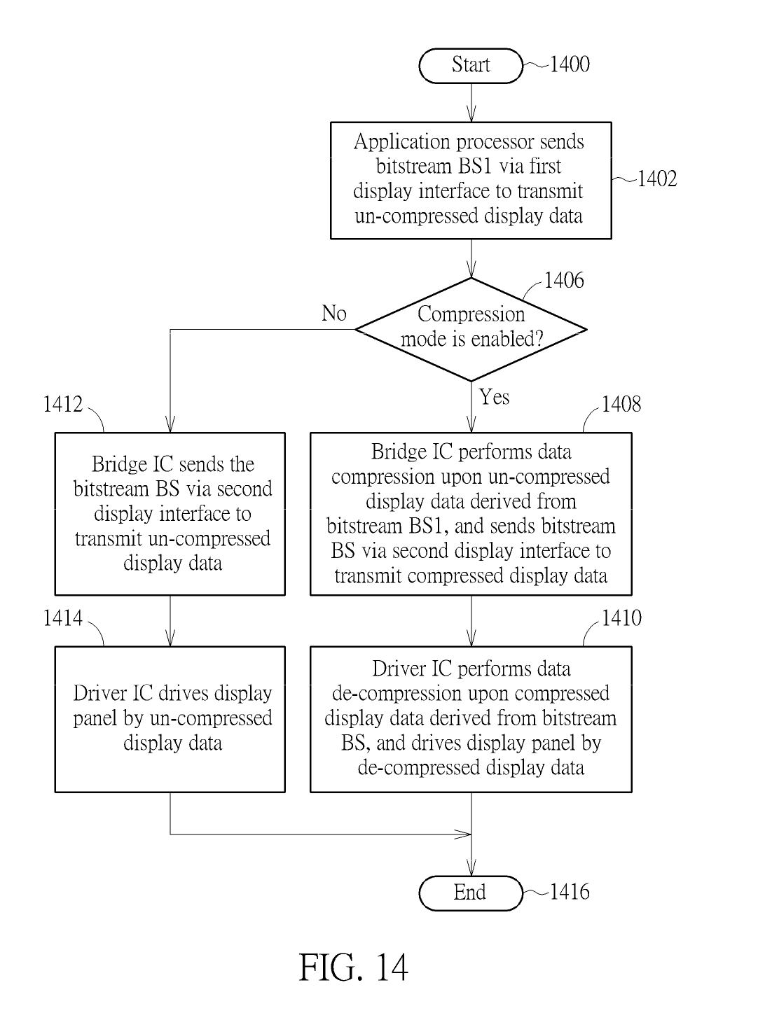

FIG. 14 is a flowchart illustrating a control and data flow of the data processing system 1300 shown in FIG. 13. Provided that the result is substantially the same, the steps are not required to be executed in the exact order shown in FIG. 14. The exemplary control and data flow may be briefly summarized by following steps.

Step 1400: Start.

Step 1402: The application processor 1302 sends the bitstream BS1 via the display interface 1303 to transmit un-compressed display data.

Step 1406: Check if the compression mode is enabled. If yes, go to step 1408; otherwise, go to step 1412.

Step 1408: The bridge IC 1306 performs data compression upon the un-compressed display data derived from the bitstream BS1, and sends the bitstream BS via the display interface 103 to transmit the compressed display data.

Step 1410: The driver IC performs data de-compression upon the compressed display data derived from the bitstream BS, and drives the display panel 138 by the de-compressed display data. Go to step 1416.

Step 1412: The bridge IC 1306 sends the bitstream BS via the display interface 103 to transmit the un-compressed display data.

Step 1414: The driver IC drives the display panel 138 by the un-compressed display data.

Step 1416: End.

As a person skilled in the art can readily understand details of each step shown in FIG. 14 after reading above paragraphs directed to the data processing system 1300 shown in FIG. 13, further description is omitted here for brevity.

In above exemplary implementation of the driver IC, the driver IC is designed to have the de-compressor included therein to support data de-compression. However, this is for illustrative purposes only, and is not meant to be a limitation of the present invention. In an alternative design, the de-compressor may be implemented in a bridge IC located between a preceding application processor and a following driver IC.

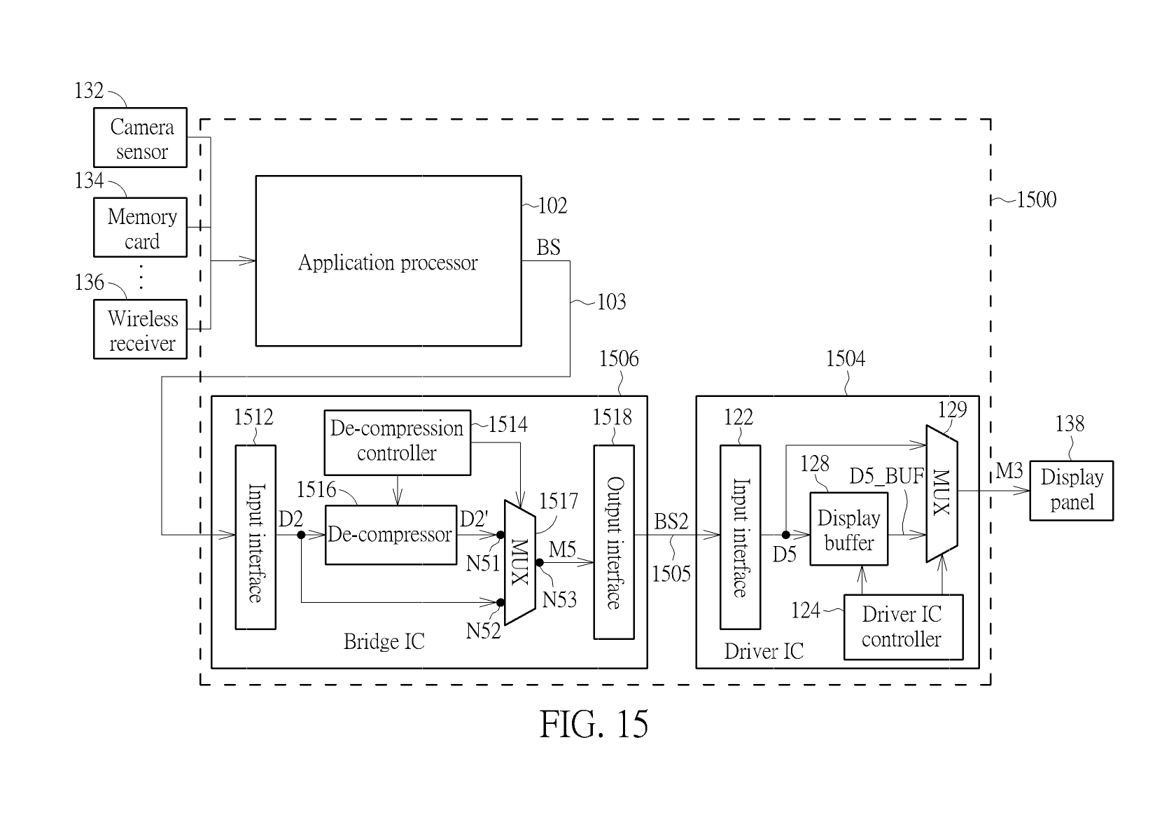

Please refer to FIG. 15, which is a block diagram illustrating a data processing system according to an eighth embodiment of the present invention. The data processing system 1500 includes a plurality of data processing apparatuses such as the aforementioned application processor 102, a driver IC 1504, and a bridge IC 1506. The application processor 102, the driver IC 1504 and the bridge IC 1506 may be different chips, where the application processor 102 communicates with the bridge IC 1506 via the aforementioned display interface 103, and the bridge IC 1506 communicates with the driver IC 1504 via a display interface 1505. By way of example, but not limitation, the display interface 1505 may be a display serial interface (DSI) standardized by a Mobile Industry Processor Interface (MIPI) or an embedded display port (eDP) standardized by a Video Electronics Standards Association (VESA).

In this embodiment, the bridge IC 1506 includes, but not limited to, an input interface 1512, a de-compression controller 1514, a de-compressor 1516, a multiplexer 1517, and an output interface 1518. The de-compression controller 1514 is arranged to control operations of the bridge IC 1506. For example, the de-compression controller 1514 controls the de-compressor 1516 and the multiplexer 1517. The bridge IC 1506 may operate in a normal/non-decompression mode or a de-compression mode. More specifically, when the application processor 102 operates under a normal/non-compression mode, the bridge IC 1506 is controlled by the de-compression controller 1514 to operate in the normal/non-decompression mode; and when the application processor 102 operates under a compression mode, the bridge IC 1506 is controlled by the de-compression controller 1514 to operate in the de-compression mode.

The input interface 1512 is arranged for receiving the bitstream BS via the display interface 103, and un-packing the bitstream BS into an input display data D2. More specifically, the input interface 1512 un-packetizes the bitstream BS based on the transmission protocol of the display interface 103. As shown in FIG. 15, the multiplexer 1517 has a plurality of input ports N51, N52 and an output port N53. The input port N51 is arranged for receiving a de-compressed display data D2′ generated from the de-compressor 1516 by applying data de-compression to the input display data D2. The input port N52 is arranged for receiving the input display data D2 generated from the input interface 1512. The output port N53 is arranged for selectively outputting the input display data D2 or the de-compressed display data D2′ as a multiplexer output M5. When the de-compression controller 1514 controls the bridge IC 1506 to operate under the normal/non-decompression mode, the de-compressor 1516 is disabled or powered off, and the multiplexer 1517 selects the input display data D2 as the multiplexer output M5 to the following output interface 1518. When the de-compression controller 1514 controls the bridge IC 1506 to operate under the de-compression mode, the de-compressor 1516 is enabled or powered on to receive the input display data D2 and generate the de-compressed display data D2′ according to the received input display data D2, and the multiplexer 1517 selects the de-compressed display data D2′ as the multiplexer output M5 to the following output interface 1518. The output interface 1518 is arranged for packing the multiplexer output M5 into a bitstream BS2 and outputting the bitstream BS2 via the display interface 1505. More specifically, the output interface 1518 packetizes the multiplexer output M5 based on the transmission protocol of the display interface 1505.

The driver IC 1504 is arranged for receiving the bitstream BS2 via the display interface 1505, and driving the display panel 138 according to display data carried by the bitstream BS2. As shown in FIG. 15, the driver IC 1504 includes the aforementioned input interface 122, driver IC controller 124, display buffer 128, and multiplexer 129. In this embodiment, the input interface 122 derives the input display data D5 from the bitstream BS2. When the video mode is selected for driving the display panel 138, the multiplexer 129 selects the input display data D5 as the multiplexer output M3. When the image/command mode is selected for driving the display panel 138, the input display data D5 is stored into the display buffer 128, and the multiplexer 129 selects the buffered display data D5_BUF as the multiplexer output M3.

As the bridge IC 1506 is equipped with data de-compression capability, the driver IC 1504 is allowed to be implemented using any decompressor-free driver IC. The same objective of reducing the transmission data rate over a display interface (e.g., 103) between an application processor and a driver IC for power consumption reduction is achieved.

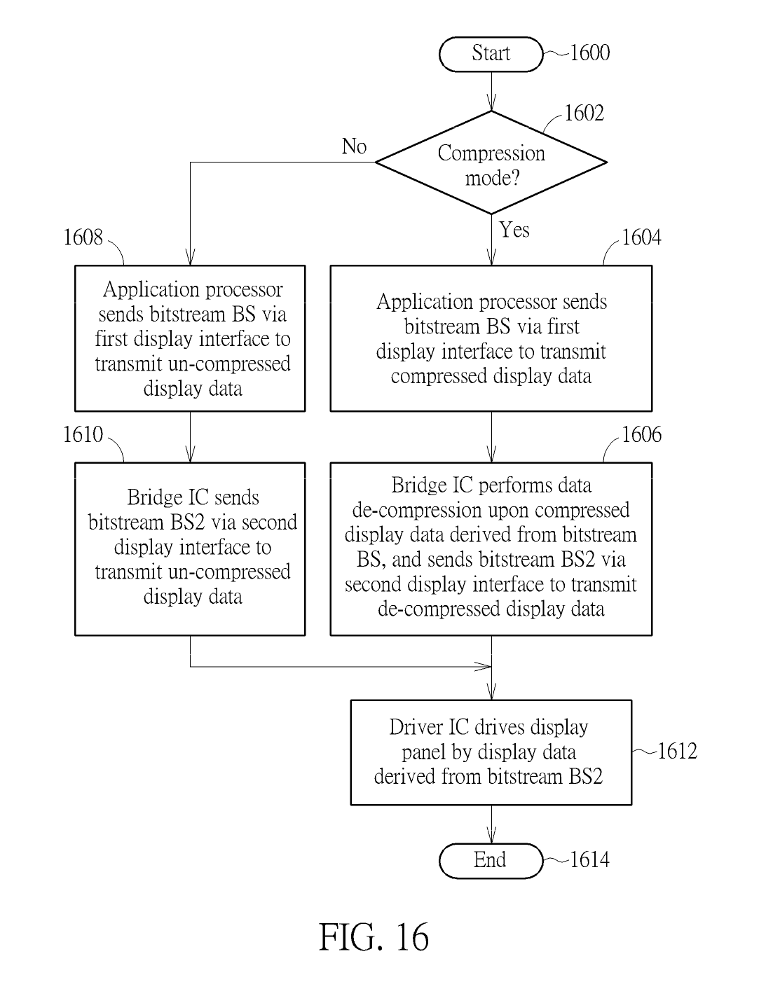

FIG. 16 is a flowchart illustrating a control and data flow of the data processing system 1500 shown in FIG. 15. Provided that the result is substantially the same, the steps are not required to be executed in the exact order shown in FIG. 16. The exemplary control and data flow may be briefly summarized by following steps.

Step 1600: Start.

Step 1602: Check if the compression mode is enabled. If yes, go to step 1604; otherwise, go to step 1608.

Step 1604: The application processor 102 sends the bitstream BS via the display interface 103 to transmit compressed display data.

Step 1606: The bridge IC 1506 performs data de-compression upon the compressed display data derived from the bitstream BS, and sends the bitstream BS2 via the display interface 1505 to transmit the de-compressed display data. Go to step 1612.

Step 1608: The application processor 102 sends the bitstream BS via the display interface 103 to transmit un-compressed display data.

Step 1610: The bridge IC 1506 sends the bitstream BS2 via the display interface 1505 to transmit the un-compressed display data.

Step 1612: The driver IC 1504 drives the display panel 138 by the display data derived from the bitstream BS2.

Step 1614: End.

As a person skilled in the art can readily understand details of each step shown in FIG. 16 after reading above paragraphs directed to the data processing system 1500 shown in FIG. 15, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing system comprising:
a first data processing apparatus, comprising:
a first controller, arranged for controlling operations of the first data processing apparatus;
a display processor, arranged for generating a first input display data;
a compressor, arranged for receiving the first input display data and generating a compressed display data according to the first input display data; and
an output interface, arranged for packing the compressed display data into a bitstream, and outputting the bitstream via a display interface; and
a second data processing apparatus, for driving a display apparatus, comprising:
an input interface, arranged for receiving the bitstream via the display interface, and un-packing the bitstream into a second input display data;
a second controller, arranged for controlling operations of the second data processing apparatus;
a display buffer, arranged for buffering the second input display data and outputting a buffered display data; and
a de-compressor, arranged for de-compressing the buffered display data when receiving the buffered display data.

2. The data processing system of claim 1, wherein the display interface is a display serial interface (DSI) standardized by a Mobile Industry Processor Interface (MIPI) or an embedded display port (eDP) standardized by a Video Electronics Standards Association (VESA).

3. The data processing system of claim 1, wherein the second data processing apparatus further comprises:
a multiplexer, comprising:
a first input port, arranged for receiving the second input display data from the input interface;
a second input port, arranged for receiving the buffered display data from the display buffer; and
an output port, arranged for selectively outputting the second input display data or the buffered display data to the de-compressor;
wherein the de-compressor is further arranged for de-compressing the second input display data when receiving the second input display data.

4. A data processing system comprising:
a first data processing apparatus, comprising:
a first controller, arranged for controlling operations of the first data processing apparatus;
a display processor, arranged for generating a first input display data;
a compressor, arranged for receiving the first input display data and generating a compressed display data according to the first input display data; and
an output interface, arranged for packing the compressed display data into a bitstream, and outputting the bitstream via a display interface; and
a second data processing apparatus, for driving a display apparatus, comprising:
an input interface, arranged for receiving the bitstream via the display interface, and un-packing the bitstream into a second input display data;
a second controller, arranged for controlling operations of the second data processing apparatus; and
a de-compressor, arranged for de-compressing the second input display data.

5. The data processing system of claim 4, wherein the display interface is a display serial interface (DSI) standardized by a Mobile Industry Processor Interface (MIPI) or an embedded display port (eDP) standardized by a Video Electronics Standards Association (VESA).

6. A data processing system comprising:
a first data processing apparatus, arranged for generating a first input display data, packing the first input display data into a first bitstream, and outputting the first bitstream via a first display interface;
a second data processing apparatus, comprising:
a first input interface, arranged for receiving the first bitstream via the first display interface, and un-packing the first bitstream into a second input display data;
a compressor, arranged for receiving the first input display data and generating a compressed display data according to the first input display data; and
an output interface, arranged for packing the compressed display data into a second bitstream, and outputting the second bitstream via a second display interface; and
a third data processing apparatus, for driving a display apparatus, comprising:
a second input interface, arranged for receiving the second bitstream via the second display interface, and un-packing the second bitstream into a third input display data;
a second controller, arranged for controlling operations of the third data processing apparatus;
a display buffer, arranged for buffering the third input display data and outputting a buffered display data; and
a de-compressor, arranged for de-compressing the buffered display data when receiving the buffered display data.

7. The data processing system of claim 6, wherein at least one of the first and second display interfaces is a display serial interface (DSI) standardized by a Mobile Industry Processor Interface (MIPI) or an embedded display port (eDP) standardized by a Video Electronics Standards Association (VESA).

8. The data processing system of claim 6, wherein the third data processing apparatus further comprises:
a multiplexer, comprising:
a first input port, arranged for receiving the third input display data from the second input interface;
a second input port, arranged for receiving the buffered display data from the display buffer; and
an output port, arranged for selectively outputting the third input display data or the buffered display data to the de-compressor;
wherein the de-compressor is further arranged for de-compressing the third input display data when receiving the third input display data.

9. A data processing system comprising:
a first data processing apparatus, arranged for generating a first input display data, packing the first input display data into a first bitstream, and outputting the first bitstream via a first display interface;
a second data processing apparatus, comprising:
a first input interface, arranged for receiving the first bitstream via the first display interface, and un-packing the first bitstream into a second input display data;
a compressor, arranged for receiving the first input display data and generating a compressed display data according to the first input display data; and
a second output interface, arranged for packing the compressed display data into a second bitstream, and outputting the second bitstream via a second display interface; and
a third data processing apparatus, for driving a display apparatus, comprising:
a second input interface, arranged for receiving the second bitstream via the second display interface, and un-packing the second bitstream into a third input display data;
a second controller, arranged for controlling operations of the third data processing apparatus; and
a de-compressor, arranged for de-compressing the third input display data.

10. The data processing system of claim 9, wherein at least one of the first and second display interfaces is a display serial interface (DSI) standardized by a Mobile Industry Processor Interface (MIPI) or an embedded display port (eDP) standardized by a Video Electronics Standards Association (VESA).

11. A data processing system comprising:
a first data processing apparatus, comprising:
a controller, arranged for controlling operations of the first data processing apparatus;
a display processor, arranged for generating a first input display data;
a compressor, arranged for receiving the first input display data and generating a compressed display data according to the first input display data; and
a first output interface, arranged for packing the compressed display data into a first bitstream, and outputting the first bitstream via a first display interface;
a second data processing apparatus, comprising:
an input interface, arranged for receiving the first bitstream via the first display interface, and un-packing the first bitstream into a second input display data;
a de-compressor, arranged for generating a de-compressed display data according to the second input display data; and
a second output interface, arranged for packing the de-compressed display data into a second bitstream, and outputting the second bitstream via a second display interface; and
a third data processing apparatus, arranged for receiving the second bitstream and driving a display apparatus according to the de-compressed display data derived from the second bitstream.

12. The data processing system of claim 11, wherein at least one of the first and second display interfaces is a display serial interface (DSI) standardized by a Mobile Industry Processor Interface (MIPI) or an embedded display port (eDP) standardized by a Video Electronics Standards Association (VESA).

13. A data processing system comprising:
a first data processing apparatus, comprising:
a first controller, arranged for controlling operations of the first data processing apparatus;
a display processor, arranged for generating a first input display data;
a compressor, arranged for receiving the first input display data and generating a compressed display data according to the first input display data; and
an output interface, arranged for packing the compressed display data into a bitstream, and outputting the bitstream via a display interface; and
a second data processing apparatus, for driving a display apparatus, comprising:
an input interface, arranged for receiving the bitstream via the display interface, and un-packing the bitstream into a second input display data;
a second controller, arranged for controlling operations of the second data processing apparatus; and
a de-compressor, arranged for generating a de-compressed display data according to the second input display data when the second input display data is the compressed display data.

14. The data processing system of claim 13, wherein the display interface is a display serial interface (DSI) standardized by a Mobile Industry Processor Interface (MIPI) or an embedded display port (eDP) standardized by a Video Electronics Standards Association (VESA).

15. The data processing system of claim 13, wherein when the second input display data is the compressed display data, the de-compressed display data is transmitted from the de-compressor to the display apparatus without data buffering.

16. The data processing system of claim 13, wherein the second data processing apparatus further comprises:
a display buffer, arranged for buffering the de-compressed display data and outputting a buffered display data when the second input display data is the compressed display data; and
a multiplexer, comprising:
a first input port, arranged for receiving the de-compressed display data from the de-compressor;
a second input port, arranged for receiving the buffered display data from the display buffer; and
an output port, arranged for selectively outputting the de-compressed display data or the buffered display data to the display apparatus.

17. The data processing system of claim 13, wherein the second data processing apparatus further comprises:
a display buffer, arranged for buffering the second input display data and outputting a buffered display data when the second input display data is not the compressed display data; and
a multiplexer, comprising:
a first input port, arranged for receiving the de-compressed display data from the de-compressor;
a second input port, arranged for receiving the buffered display data from the display buffer; and
an output port, arranged for selectively outputting the de-compressed display data or the buffered display data to the display apparatus.

18. The data processing system of claim 13, wherein the second data processing apparatus further comprises:
a display buffer, arranged for buffering the de-compressed display data and outputting a buffered display data to the display apparatus when the second input display data is the compressed display data.

19. The data processing system of claim 18, wherein the second data processing apparatus further comprises:
a multiplexer, comprising:
a first input port, arranged for receiving the second input display data from the input interface;
a second input port, arranged for receiving the buffered display data from the display buffer; and
an output port, arranged for outputting the second input display data to the display apparatus when the second input display data is not the compressed display data, and outputting the buffered display data to the display apparatus when the second input display data is the compressed display data.
